(19) United States
(12) Patent Application Publication
(10) Pub. No.: US 2020/0291896 A1
(43) Pub. Date: Sep. 17, 2020

(54) ACOUSTIC PANEL FOR AN AIRCRAFT TURBOJET NACELLE, AND METHOD FOR MANUFACTURING AN ELEMENT OF A NACELLE

(71) Applicant: Safran Nacelles, GONFREVILLE L'ORCHER (FR)

(72) Inventors: Philippe BIENVENU, MOISSY CRAMAYEL (FR); Olivier BONMARTEL, MOISSY CRAMAYEL (FR); Aurélie SOULA, MOISSY CRAMAYEL (FR); Thomas PERROTIN, MOISSY CRAMAYEL (FR); Serge BELINY, MOISSY CRAMAYEL (FR)

(73) Assignee: Safran Nacelles, GONFREVILLE L'ORCHER (FR)

(21) Appl. No.: 16/887,501

(22) Filed: May 29, 2020

Related U.S. Application Data
(63) Continuation of application No. PCT/FR2018/053036, filed on Nov. 29, 2018.

(30) Foreign Application Priority Data
Nov. 30, 2017 (FR) 1761415

(51) Int. Cl. F02K 1/82; B64C 7/02; B32B 3/12; F02C 7/045

(52) U.S. Cl. CPC F02K 1/827; B64C 7/02; F05D 2230/51; F02C 7/045; F05D 2230/236; B32B 3/12

(57) ABSTRACT

An acoustic panel for an aircraft turbojet nacelle, of the type including an outer skin, an inner skin, and a cellular core which is interposed between the outer skin and the inner skin, includes a plurality of corrugated strips, each corrugated strip extending longitudinally in length while forming a succession of bosses and recesses, the corrugated strips arranged to delimit cells which extend globally perpendicularly to the skins. Each corrugated strip extends in width from a first end forming an outer folded edge, which bears on the outer skin, to a second end forming an inner folded edge, which bears on the inner skin.

### CROSS-REFERENCE TO RELATED APPLICATIONS

This application is a continuation of International Application No. PCT/FR2018/053036, filed on Nov. 29, 2018, which claims priority to and the benefit of FR 17/61415 filed on Nov. 30, 2017. The disclosures of the above applications are incorporated herein by reference.

### FIELD

The present disclosure relates to an acoustic panel for an aircraft turbojet engine nacelle as well as a method for manufacturing such an acoustic panel.

### BACKGROUND

The statements in this section merely provide background information related to the present disclosure and may not constitute prior art.

It is known to implement acoustic panels, commonly called “sandwich panels,” which are panels adapted to attenuate the noise emitted from the interior of a turbojet engine nacelle, for example.

Such an acoustic panel typically comprises an outer skin, an inner skin, and a cellular core which is interposed between the outer skin and the inner skin.

The cellular core comprises a plurality of corrugated strips, each corrugated strip extending longitudinally in length by forming a succession of bumps and hollows.

The corrugated strips are arranged so as to delimit cells which extend perpendicularly to each skin.

The cells form Helmholtz cavities which are adapted to attenuate the sounds.

Also, the inner skin which is intended to be oriented towards the source of noise is permeable to air in order to absorb the acoustic energy within the cellular core.

This type of panel makes it possible in particular to manufacture an ejection nozzle or an inner fixed structure of a nacelle.

There is known in the prior art a method for manufacturing an element of a nacelle comprising an acoustic panel of the previously described type, the element of the nacelle possibly being an ejection nozzle or an annular inner structure of a nacelle.

The manufacturing method according to the prior art successively comprises a step of flat manufacturing the acoustic panel which consists in fixing the outer skin and the inner skin on the cellular core, and a shaping step which consists in giving a shape to the previously made panel, as a revolution shape.

This type of method has several drawbacks.

Indeed, this type of method does not allow the manufacture of a nacelle element of a complex shape. The term “complex shape” means here an element which has a portion of a revolution shape and a flat portion for example.

Similarly, the minimum radius of curvature of a nacelle element produced by this type of method is limited.

In addition, according to this type of method, the outer skin and the inner skin are fixed on the cellular core by brazing.

Brazing consists of heating a filler metal to its melting temperature, which can take the shape of a brazing sheet.

Typically, the brazing sheet is placed between a skin and the cellular core of the panel.

The high cost of the brazing sheets makes brazing expensive.

### SUMMARY

This section provides a general summary of the disclosure and is not a comprehensive disclosure of its full scope or all of its features.

The present disclosure relates to an acoustic panel which is adapted to be manufactured by a method which allows the production of complex shapes and at lower cost.

The present disclosure concerns more particularly an acoustic panel for an aircraft turbojet engine nacelle, of the type including: an outer skin, an inner skin, and a cellular core which is interposed between the outer skin and the inner skin and which comprises a plurality of corrugated strips, each of the corrugated strips extending longitudinally in length by forming a succession of bumps and hollows, and the corrugated strips being arranged so as to delimit cells which extend generally perpendicular to the skins, wherein that each corrugated strip extends in width from a first end forming an outer folded edge which is bearing on the outer skin, to a second end forming an inner folded edge which is bearing on the inner skin.

The folded edges make it possible to increase the contact surface between the cellular core and the associated skins, in order to promote the fixing of the cellular core on the associated skins.

According to another characteristic, at least one portion of the folded edges has a truncated portion to inhibit excess thickness by superposition of two folded edges.

This characteristic makes it possible to inhibit excess thickness by the overlap of two folded edges, which could harm the fixing of the cellular core on the associated skins.

According to another characteristic, the corrugated strips are offset in the direction of their length so that the bumps and the hollows of two adjacent corrugated strips are in contact to form the cells.

The present disclosure also concerns an element of a turbojet engine nacelle which includes at least one acoustic panel of the previously described type.

According to another characteristic, the nacelle element forms an ejection nozzle or an inner structure of a turbojet engine nacelle.

The present disclosure also concerns a method for manufacturing an element of a turbojet engine nacelle comprising at least one acoustic panel of the previously described type, characterized in that it comprises: a step of manufacturing the cellular core, a step of shaping the cellular core, a step of shaping the outer skin, a step of shaping the inner skin, and an assembly step which is carried out following the steps of shaping the skins, and which comprises assembling the cellular core, the outer skin and the inner skin in order to produce the element of the nacelle.

This characteristic, which comprises forming the skins before they are assembled on the cellular core, makes it possible to limit the deformation of the cellular core.

According to another characteristic, the assembly step is carried out by diffusion welding.

Diffusion welding makes it possible in particular to limit manufacturing costs.

According to another characteristic, each shaping step comprises giving a final shape to the shaped element.

According to another characteristic, the method includes an acoustic treatment step which comprises perforating the outer skin.

According to another characteristic, the step of manufacturing the cellular core comprises: a shaping phase which comprises forming the corrugated strips, each corrugated strip forming a succession of bumps and hollows, and each corrugated strip extending in width from a first end forming an outer folded edge which is configured to be bearing on the outer skin, up to a second end forming an inner folded edge which is configured to be bearing on the inner skin, and a phase of assembling the corrugated strips together.

According to another characteristic, the step of manufacturing the cellular core comprises a punching phase, which is carried out following the shaping phase of the cellular core and which comprises truncating a portion of at least one portion of the folded edges to inhibit an excess thickness by superposition of two edges folds.

According to another characteristic, the shaping phase which comprises forming the corrugated strips is carried out by stamping.

According to another characteristic, the phase of assembling the corrugated strips to manufacture the cellular core is carried out by welding.

According to another characteristic, the method comprises a step of protection against oxidation of the cellular core which comprises protecting all the surface of the corrugated strips by an anticorrosion protective layer, with the exception of the face of each folded edge which is configured to be bearing on one of the skins of the acoustic panel.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is an exploded perspective view which illustrates a nozzle of a nacelle which comprises an outer skin, a honeycomb cellular core and an inner skin, according to the present disclosure;

FIG. 2 is a perspective view which illustrates an inner fixed structure of a nacelle for a turbojet engine, comprising an acoustic panel, according to the present disclosure;

FIG. 3 is a schematic view in radial section which illustrates the acoustic panel of FIG. 2;

FIG. 4 is a detailed perspective view which illustrates a corrugated strip with folded edges belonging to the cellular core of FIG. 2;

FIG. 5 is a schematic view of a portion of the cellular core of FIG. 2 comprising a plurality of corrugated strips with punched folded edges;

FIG. 6 is a schematic view which illustrates the outer skin of the acoustic panel arranged in a half-tool of tooling for implementing a manufacturing method according to the present disclosure;

FIG. 7 is a schematic view which illustrates the outer skin, the inner skin and the cellular core of the acoustic panel arranged in the half-tool of FIG. 6; and

FIG. 8 is a schematic view similar to that of FIG. 6, which illustrates the outer skin, the inner skin and the cellular core of the acoustic panel arranged in the two half-tools of the tooling of FIG. 6.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

There is represented in FIG. 2 an acoustic panel 10 which forms a first inner half-structure 14a of an aircraft turbojet engine nacelle.

The first inner half-structure 14a has a complex shape which comprises a portion of a revolution shape 16 about the axis A whose generatrix is curved and two generally planar radial portions 18.

The first inner half-structure 14a is designed to be assembled with a complementary 20 second inner half-structure 14b, visible in FIG. 8, to form an element 41 (an inner structure) of the turbojet engine nacelle.

With reference to FIG. 3, the acoustic panel 10 comprises an outer skin 22, an inner skin 24 and a cellular core 26.

According to the form described here, the outer skin 22 and the inner skin 24 are made of titanium.

Without limitation, the outer skin 22 and the inner skin 24 can be made with different types of alloys/materials, in particular a nickel alloy known under the trade name “INCONEL®.”

The cellular core 26 is interposed between the outer skin 22 and the inner skin 24 radially with respect to the central axis A.

There is represented in FIG. 4 a corrugated strip 28 which extends in length by forming a succession of bumps 30 and hollows 32.

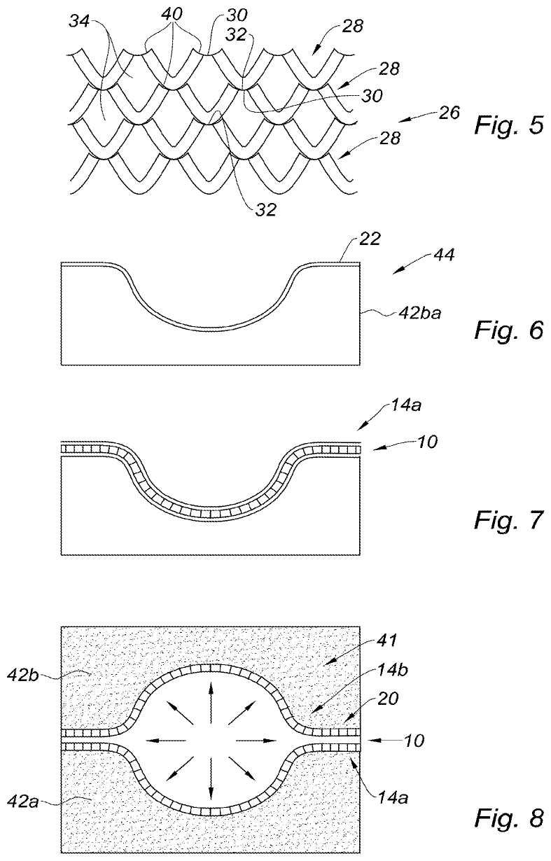

The cellular core 26, illustrated in FIG. 5, comprises a plurality of corrugated strips 28 which are arranged so as to delimit cells 34 which extend radially perpendicular to the outer skin 22 and to the inner skin 24.

To this end, the corrugated strips 28 are offset in the direction of their length so that the bumps 30 and the hollows 32 of two adjacent corrugated strips 28 are in contact so as to form the cells 34.

The corrugated strips 28 are fixed to each other, for example by welding.

As can be seen in FIG. 3, the corrugated strips 28 which form the cellular core 26 extend along their length about the axis A of the acoustic panel 10.

With reference to FIG. 4, each corrugated strip 28 extends in width from a first end forming an outer folded edge 36 which is bearing on the outer skin 22, up to a second end forming an inner folded edge 38 which is bearing on the inner skin 24.

The outer folded edge 36 and the inner folded edge 38 are provided for increasing the contact surface between each corrugated strip 28 and the outer skin 22 and the inner skin 24, to promote the fixing of the corrugated strips 28 on the associated skins.

According to FIG. 5, the outer folded edge 36 and the inner folded edge 38 of each corrugated strip 28 have reduced portions 40 to inhibit excess thickness by superposition of two folded edges.

In fact, it can be seen that the absence of excess thickness by superposition of two folded edges promotes the fixing of the folded edges 36, 38 on the associated skin 22, 24.

The term “reduced portion” 40 means a portion whose thickness is reduced so that the reduced portion has a thickness comprised between zero millimeter and half the thickness of the corrugated strip 28.

According to one form, the thickness of the reduced portion 40 is zero, so it is a truncated portion, for example by punching or by laser cutting.

According to a variant, the thickness of the reduced portion 40 is equal to or less than half the thickness of the corrugated strip 28. Such a reduced portion 40 is obtained by crushing during the stamping of the corrugated strip 28 for example.

According to the described form, each reduced portion 40 of a folded edge is arranged in the vicinity of each bump 30 of each corrugated strip 28.

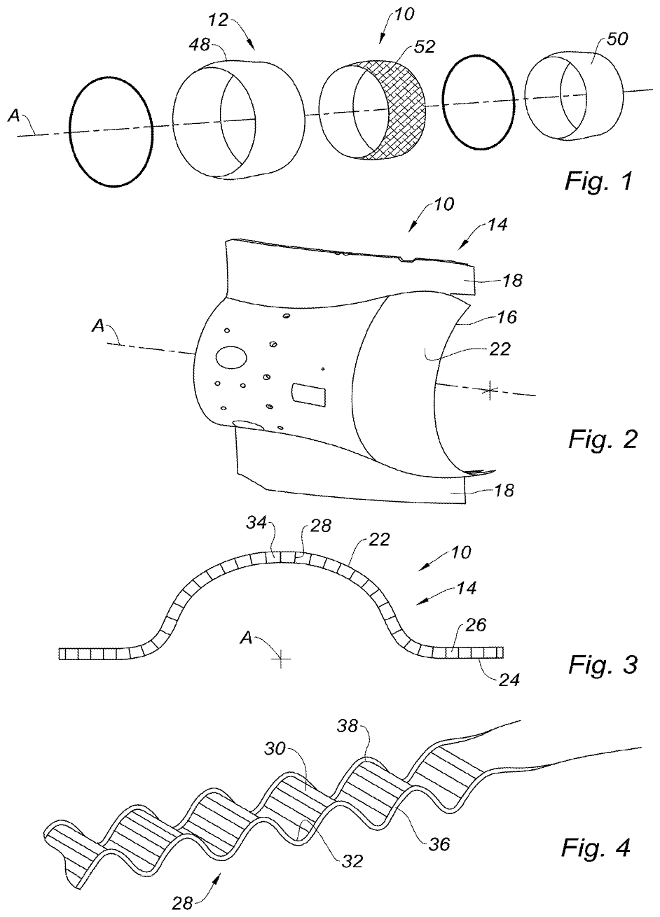

The present disclosure also applies to the production of a nacelle element which comprises an acoustic panel 10 and which forms an annular nozzle 12 of a general barrel shape about a central axis A of revolution, as can be seen in FIG. 1.

The annular nozzle 12 comprises an outer skin 48, an inner skin 50 and a cellular core 52 similar to the cellular core 26 previously described.

The present disclosure also concerns a method for manufacturing an element 41 of a turbojet engine nacelle.

According to the selected form, the element 41 is an inner structure which comprises a first inner half-structure 14a of the previously described type, and a second inner half-structure 14b identical to the first, as can be see FIG. 8.

For the sake of clarity, only the steps of manufacturing the first inner half-structure 14a are described below, the second inner half-structure 14b being identical to the first one.

The manufacturing method comprises a step of manufacturing the cellular core 26 which is followed by a step of shaping the cellular core 26.

The step of manufacturing the cellular core 26 comprises a reducing phase which includes reducing a portion of each corrugated strip 28 to inhibit an excess thickness by superposition of two folded edges.

The reducing phase comprises locally truncating each corrugated strip 28 to form the reduced portions 40, so that following the shaping phase described below, so that the outer folded edge 36 and the inner folded edge 38 of each corrugated strip 28 has a reduced portion 40 in the vicinity of each bump 30.

Without limitation, it is also possible to locally crush each corrugated strip 28 to form the reduced portions 40.

The step of manufacturing the cellular core 26 comprises a shaping phase, which is carried out following the reducing phase, and which comprises forming the corrugated strips 28, that is to say forming the bumps 30, the hollows 32, the outer folded edge 36 and the inner folded edge 38 of each corrugated strip 28.

The corrugated strips 28 are formed by stamping a sheet, for example.

It is possible to carry out the reducing phase by local crushing and the shaping phase simultaneously, during the stamping of the corrugated strips 28.

In addition, the step of manufacturing the cellular core 26 comprises a phase of assembling the corrugated strips 28 which is carried out following the shaping phase previously described, and which comprises fixing the corrugated strips 28 in view of fabricating the cellular core 26.

The fixing of the corrugated strips 28 is for example carried out by welding of the edges which delimit the bumps 30 and the hollows 32 of each corrugation of each corrugated strip 28.

Furthermore, the method comprises a step of protection against oxidation of the cellular core 26 which comprises protecting all the surfaces of the corrugated strips 28 with an anticorrosion protective layer, with the exception of the face of each folded edge 36, 38 which is configured to be bearing on one of the skins 22, 24 of the acoustic panel 10.

The protection step can be carried out by protecting the folded edges 36, 38 by a masking element, then by depositing the anticorrosion protective layer on each corrugated strip 28.

Alternatively, it is also possible to deposit an anticorrosion protective layer over the entire surface of the corrugated strips 28, then to remove the protective layer deposited on the face of each folded edge 36, 38 which is configured to be bearing on one of the skins 22, 24.

In one form, the anticorrosion protective layer is a nickel and chromium-based layer.

Following the step of manufacturing the cellular core 26, the step of shaping the cellular core 26 comprises giving the cellular core its final shape, i.e. a shape of an inner half-structure 14 according to the described exemplary embodiment.

The shaping of the cellular core 26 can be carried out hot or cold.

Also, the method comprises a step of shaping the outer skin 22 and a step of shaping the inner skin 24, which comprises giving the outer skin 22 and the inner skin 24 its final shape, for example by stamping a sheet.

The method also includes an acoustic treatment step which comprises perforating the outer skin 22.

Finally, the method according to the present disclosure comprises an assembly step which is carried out following the steps of shaping the skins 22, 24 and which comprises assembling the cellular core 26, the outer skin 22 and the inner skin 24 with a view to produce the first inner half-structure 14a.

With reference to FIG. 6, the assembly step comprises arranging the outer skin 22 in a first half-tool 42a of a tooling 44, the half-tool 42a having a shape which matches the shape of the outer skin 22.

The assembly step then includes a phase of arranging the cellular core 26 against the outer skin 22, then a phase of arranging the inner skin 24 on the cellular core 26, as can be seen in FIG. 6.

The assembly step is repeated to form a second inner half-structure 14b by a second half-tool 42b of the tooling 44.

The assembly step comprises a diffusion welding phase under gas pressure which makes it possible to fix the outer skin 22 and the inner skin 24 on the cellular core 26 of each inner half-structure 14a, 14b.

To carry out the diffusion welding phase, it is necessary to increase the gas pressure within the tooling 44.

For this purpose, the ends of the tooling 44 are each closed by a plug (not represented).

According to a non-represented variant, each inner half-structure 14a, 14b is separately assembled by diffusion welding by two distinct tools.

According to this variant, each tool comprises a counter-shape which matches the shape of the inner half-structure 14a, 14b and a cover which cooperates with the counter-shape to allow increasing the gaseous pressure in the tooling during the diffusion welding.

The method according to the present disclosure aims to separately shape the outer skin 22 and inner skin 24 firstly, then to assemble the skins 22, 24 with the cellular core 26 in a second step, unlike a method according to the prior art which comprises assembling the skins and the flat cellular core, then forming the whole.

The method according to the present disclosure makes it possible to limit, or reduce, the unwanted deformations of the cellular core 26.

Particularly, the method according to the present disclosure makes it possible to do little or no deformation of the folded edges of the corrugated strips 28 of the cellular core 26.

The present description is given by way of non-limiting example.

According to a non-represented variant, only the inner skin 24 is assembled on the cellular core by diffusion welding during the assembly step.

According to this variant, the outer skin 22 can be made of composite or aluminum for example and assembled on the cellular core 26, for example by bonding.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. An acoustic panel for an aircraft turbojet engine nacelle, the acoustic panel including:
an outer skin,
an inner skin, and
a cellular core interposed between the outer skin and the inner skin, the cellular core comprising a plurality of corrugated strips,
wherein each corrugated strip of the plurality of corrugated strips extends longitudinally in length forming a succession of bumps and hollows, the plurality of corrugated strips being arranged so as to delimit cells which extend generally perpendicular to the outer and inner skins, and each corrugated strip extending in width from a first end forming an outer folded edge which bears on the outer skin, up to a second end forming an inner folded edge which bears on the inner skin,
wherein at least one portion of the outer folded edge has a reduced portion, and at least one portion of the inner folded edge has a reduced portion.

2. The acoustic panel according to claim 1, wherein each reduced portion is truncated.

3. The acoustic panel according to claim 1, wherein the plurality of corrugated strips are offset in direction of their length so that the succession of bumps and hollows of two adjacent corrugated strips are in contact so as to form the cells.

4. An element of a turbojet engine nacelle which includes at least one acoustic panel according to claim 1.

5. The element according to claim 4, wherein the element is an ejection nozzle or an inner structure of a turbojet engine nacelle.

6. A method for manufacturing an element of a turbojet engine nacelle comprising at least one acoustic panel according to claim 1, the method comprising:
manufacturing the cellular core;
shaping the cellular core;
shaping the outer skin;
shaping the inner skin; and
assembling the cellular core, the outer skin, and the inner skin to produce the element of the turbojet engine nacelle.

7. The method according to claim 6, wherein assembling the cellular core is carried out by diffusion welding.

8. The method according to claim 6, wherein shaping the cellular core comprises giving a final shape to the cellular core, shaping the outer skin comprises giving a final shape to the outer skin, and shaping the inner skin comprises giving a final shape to the inner skin.

9. The method according to claim 6, wherein manufacturing the cellular core comprises:
a shaping phase which comprises forming the plurality of corrugated strips, each corrugated strip forming the succession of bumps and hollows, and each corrugated strip extending in width from a first end forming an outer folded edge configured to bear on the outer skin, up to a second end forming an inner folded edge configured to bear on the inner skin, and
a phase of assembling the plurality of corrugated strips together.

10. The method according to claim 9, wherein manufacturing the cellular core further comprises a reducing phase which comprises making reduced portions by reducing at least one portion of the outer folded edge of each corrugated strip, and reducing at least one portion of the inner folded edge of each corrugated strip.

11. The method according to claim 10, wherein the reducing phase is carried out by punching the at least one portion of the outer folded edge and the at least one portion of the inner folded edge of each corrugated strip, wherein each reduced portion is truncated by punching.

12. The method according to claim 9, wherein the shaping phase is carried out by stamping.

13. The method according to claim 9, wherein the phase of assembling the plurality of corrugated strips for manufacturing the cellular core is carried out by welding.

14. The method according to claim 6, further comprising protecting all surfaces of the plurality of corrugated strips with an anticorrosion protective layer, except the surfaces of each outer folded edge and inner folded edge which are configured to bear respectively on the outer skin and the inner skin of the acoustic panel.
